(19) United States
(12) Patent Application Publication
(10) Pub. No.: US 2026/0134654 A1
(43) Pub. Date: May 14, 2026

(54) DEVICE AND METHODS FOR USING AI-MEDIATED IMAGING TO MEASURE, OPTIMIZE, IMPLANT, TRACK AND PROGRAM SURGICALLY IMPLANTED NEUROMODULATION IN RESEARCH AND CLINICAL APPLICATIONS

(71) Applicants: Regents of the University of Minnesota, Minneapolis, MN (US); University of St. Thomas, St. Paul, MN (US)

(72) Inventors: Dwight E. Nelson, Minneapolis, MN (US); Chih Lai, St. Paul, MN (US); Jihun Moon, St. Paul, MN (US); Nissrine Nakib, Minneapolis, MN (US); Mohamed Ahmed Mohamad Mahmoud Aboelmaaty, Minneapolis, MN (US); Evelyn Arden, Minneapolis, MN (US); Bowen Yao, Minneapolis, MN (US)

(21) Appl. No.: 19/384,468

(22) Filed: Nov. 10, 2025

Related U.S. Application Data
(60) Provisional application No. 63/718,910, filed on Nov. 11, 2024.

(51) Int. Cl. G06V 10/26; G06T 7/00; G06V 10/30; G06V 10/774; G06V 40/10

(52) U.S. Cl. CPC G06V 10/273; G06T 7/0012; G06V 10/30; G06V 10/7747; G06V 40/10; G06T 2207/10116; G06T 2207/30052; G06T 2207/30196; G06V 2201/034

(57) ABSTRACT

A method of training artificial intelligence systems includes receiving a set of images each containing an object of interest and defining a set of sub-regions on each image, at least one sub-region having a smaller area than an area of the sub-region's respective image. Each sub-region that contains an entirety of the object of interest is identified as a target sub-region. Pixels in each target sub-region that correspond to the object of interest are identified to form a true object/non-object mapping for each target sub-region. The target sub-regions are used as inputs to an artificial intelligence system and the true object/non-object mappings for the target sub-regions are used as expected outputs of the artificial intelligence system during training of the artificial intelligence system.

### CROSS-REFERENCE TO RELATED APPLICATION

The present application is based on and claims the benefit of U.S. provisional patent application Ser. No. 63/718,910, filed Nov. 11, 2024, the content of which is hereby incorporated by reference in its entirety.

### BACKGROUND

The content of many images, such as radiological medical images, is difficult to determine. Because of this, some medical procedures are less successful than they could otherwise be if the content of the images was clearer.

### SUMMARY

A method of training artificial intelligence systems includes receiving a set of images each containing an object of interest and defining a set of sub-regions on each image, at least one sub-region having a smaller area than an area of the sub-region's respective image. Each sub-region that contains an entirety of the object of interest is identified as a target sub-region. Pixels in each target sub-region that correspond to the object of interest are identified to form a true object/non-object mapping for each target sub-region. The target sub-regions are used as inputs to an artificial intelligence system and the true object/non-object mappings for the target sub-regions are used as expected outputs of the artificial intelligence system during training of the artificial intelligence system.

In accordance with a further embodiment, a method of identifying the location of objects in an image includes identifying multiple sub-regions in the image that are likely to contain the objects and for each identified sub-region, designating pixels in each sub-region that are likely to represent part of the objects as an object pixel. For each pixel in the image, assigning an object designation to the pixel based on a number of identified sub-regions in which the pixel was designated as an object pixel.

In accordance with a still further embodiment, a method of training a noise-reduction model includes applying image data to a partially trained object detection model to form a first object/non-object mapping and applying the image data to a fully trained object detection model to form a second object/non-object mapping. Both the first object/non-object mapping and the second object/non-object mapping are used to train the noise reduction model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method of training an object detection model and a noise reduction model using a limited set of training images.

FIG. 2 is a block diagram of a system used in the methods described herein.

FIG. 3. is a flow diagram of a method of identifying target sub-regions of an image.

FIG. 4 is a depiction of sub-regions and an object of interest in an image.

FIG. 5 is a flow diagram of a method training an object detection model and generating training object/non-object mappings for training a noise reduction model

FIG. 6 is a flow diagram of a method of training a noise reduction model while continuing to increase the number of training object/non-object mappings that are available for training.

FIG. 7 provides a process diagram of model training in accordance with one embodiment.

FIG. 8 provides a flow diagram of a method of identifying an object of interest in an image and displaying the location of the object of interest.

FIG. 9 is a lateral image of a probe near a sacrum showing a bounded region.

FIG. 10 is a lateral image of a probe near a sacrum showing a second bounded region.

FIG. 11 is a lateral image of a lead in a sacrum showing a bounded region.

FIG. 12 is a lateral image of a lead in a sacrum showing a second bounded region.

FIG. 13 is a lateral image of a sacrum showing lines in a bounded region used to identify sacral surfaces.

### DETAILED DESCRIPTION

Artificial Intelligence systems require a large amount of training data in order to perform well. However, such data is not available in many domains where Artificial Intelligence may be useful. One particular domain where the limited amount of data poses a problem to properly training Artificial Intelligence systems is healthcare. In particular, data for medical procedures is limited due to the fact that many physicians do not collect data during the procedure and due to the fact that there are healthcare privacy laws that limit what data may be shared. In the past, Artificial Intelligence systems that were trained using small amounts of field data did not perform well and the lack of field data available for training is a technological challenge to implementing Artificial Intelligence, especially in connection with medical procedures.

In the embodiments described below, several techniques are used to expand the amount of data that is available to train Artificial Intelligence systems. Under one technique, the amount of image data that is available to train an Artificial Intelligence system is expanded by defining multiple overlapping sub-regions on an image containing an object. The multiple sub-regions are then used to train an Artificial Intelligence model instead of using just the image resulting in a large increase in the amount of data available to train the model.

Under a second technique, data for a noise reduction model is generated by using partially and fully trained models before the noise reduction model. For example, the noise reduction model can be intended to be used to remove noise from the output of an object detection model. Under the present embodiment, the same input is applied to several different partially trained versions of the object detection model as well as the fully trained object detection model resulting in multiple object detection outputs for each input. This multiplies the number of outputs available for training the noise reduction model and thus improves the performance of the noise reduction model.

In a third technique, the noise reduction model is trained in iterations with the output of the noise reduction model of prior iterations being used as noisy inputs during the training of the next version of the noise reduction model. This further multiplies the input data available for training the noise reduction model.

Individually and together, these techniques improve the Artificial Intelligence systems that are being trained by generating additional training data without requiring more data from the field, such as an operating room.

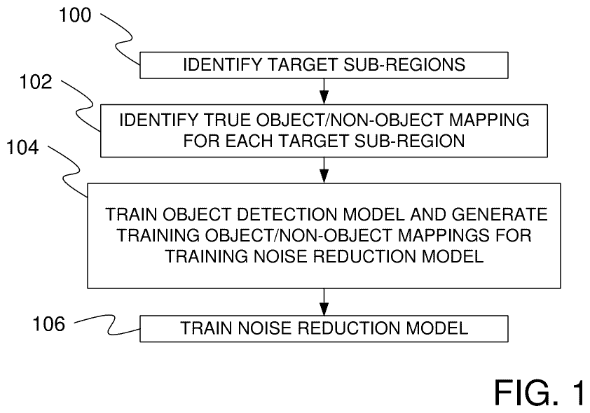

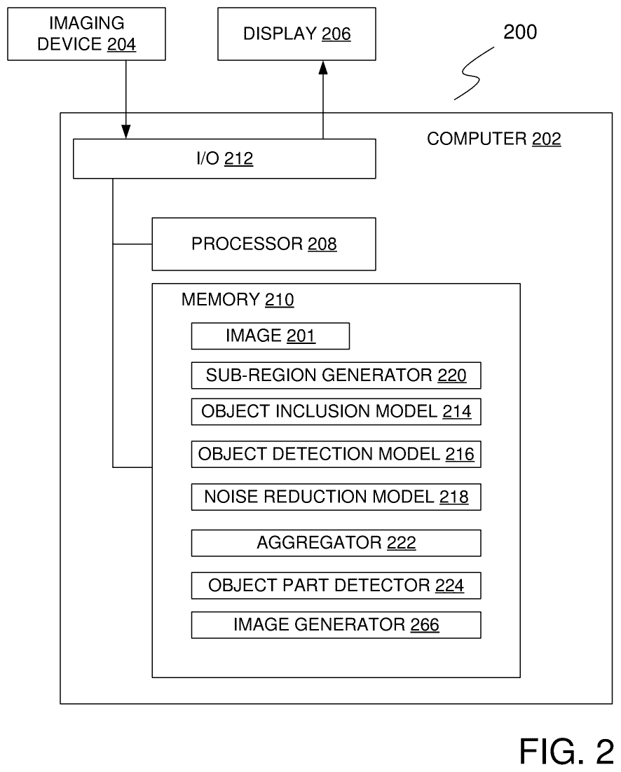

FIG. 1 provides a flow diagram of training and using a collection of Artificial Intelligence systems, also referred to as models, to locate objects in an image using a relatively small number of training images. FIG. 2 provides a block diagram of a system used in the method of FIG. 1.

System 200 of FIG. 2 consists of a computer 202, which receives images from an imaging device 204, identifies the location of one or more objects of interest in the images and displays the location of the objects on a display 206. Imaging device 204 includes devices used in radiology including fluoroscopy imaging devices that capture real time X-ray images of a living body. Computer 202 includes a processor 208, a memory 210 and an input/output interface 212 that communicates with imaging device 204 and display 206. Memory 210 contains instructions that are executed by processor 208 to perform the various methods described below and to train and implement various models. Memory 210 also contains data used during training and execution of the various models.

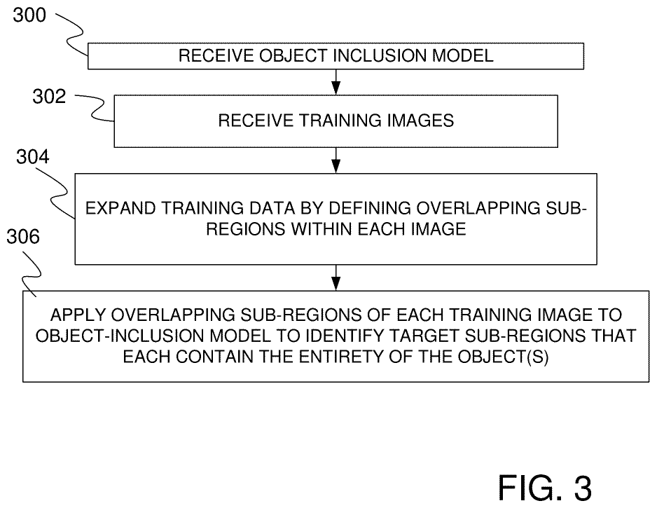

In step 100 of FIG. 1, computer 202 identifies a plurality of target sub-regions in a limited set of training images to expand the amount of data available for training an object detection model 216 and a noise reduction model 218. FIG. 3 provides a flow diagram of a method of identifying target sub-regions in accordance with one embodiment.

In step 300 of FIG. 3, computer 202 receives an object inclusion model 214 that has been trained to provide a confidence level that an object of interest appears somewhere in an image or a portion of an image without identifying the exact location of the object. In accordance with one embodiment, object inclusion model 214 can be received by training the object inclusion model.

At step 302, training images are received. The same training images received at step 302 may be used to train object inclusion model 214. In accordance with one embodiment, the training images are images of a specific medical procedure that the artificial intelligence models being trained herein are to be used with.

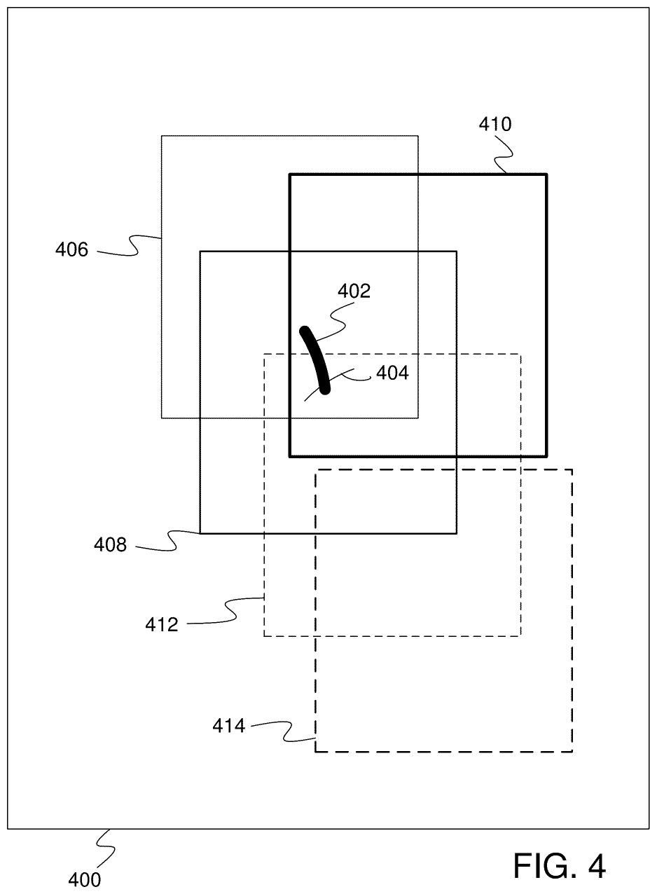

At step 304, the training data available for training the object detection model 216 and the noise reduction model 218 is expanded by defining overlapping sub-regions within each image. FIG. 4 shows examples of overlapping sub-regions 406, 408, 410, 412 and 414 defined within an image 400. Sub-regions 406, 408, 410, 412 and 414 are shown with different line thicknesses and patterns in order to make it easier to see each sub-region. In FIG. 4 only a sampling of the overlapping sub-regions is shown for clarity.

In accordance with some embodiments, each of the sub-regions have an identical shape and area and overlap at least one other sub-region. In addition, each sub-region has an area that is less than the area of the image. In accordance with one embodiment, the sub-regions are defined by a sub-region generator 220 executed by processor 208. Sub-region generator moves a fixed-sized window across the image and defining a new sub-region at each position of the window. For example, the initial position of the window can be in the upper-left corner of image 400 and the window can be initially shifted horizontally by n pixels with each shift to define a first set of sub-regions. When the shifted window reaches the right side of the image, the window can be returned to the left edge of image 400 and can be shifted down by n pixels. A new series of horizontal shifts is then performed at this vertical position to define a new set of sub-regions. The horizontal scanning and vertical shifting continue until the window reaches the lower-right corner of image 400.

As shown in FIG. 4, some of the sub-regions (for example, 406, 408 and 410) include the totality of an object of interest that consists of object parts 402 and 404. Some of the sub-regions (for example, 412) include a portion of the object of interest but not the entirety of the object of interest and some of the sub-regions (for example, 414) do not include any part of the object of interest.

At step 306, each of the sub-regions identified in step 304 are applied to object inclusion model 214 to determine which of the sub-regions (such as 406, 408 and 410) include the entirety of the object of interest and which sub-regions (such as 412 and 414) do not include an entirety of the object of interest. In accordance with one embodiment, object inclusion model 214 is trained using a confidence value such that when object inclusion model 214 indicates that a sub-region contains the entirety of the object of interest, the likelihood of the entirety of the object being within the sub-region exceeds the confidence value. In accordance with one particular, embodiment, the confidence value is 99% or greater. The sub-regions that are identified by object inclusion model 214 as including the entirety of the object of interest are designated as target sub-regions that are to be used in training object detection model 216 and noise reduction model 218. The sub-regions that are identified as not including the entirety of the object of interest are discarded and are not used in any of the steps discussed below for training the object detection model or the noise reduction model.

The identification of the target sub-regions improves training Artificial Intelligence models in several ways. First, by identifying multiple sub-regions in each image that can be used in training, the innovation multiplies the number of data samples available for training. In addition, since each sub-region is offset from other sub-regions, the object of interest appears in a different position in the sub-region and with different background elements in the sub-region with the object of interest. This provides different contexts for training the object detection model and the noise model making those model more robust against different contexts that the object of interest can be found in. Thus, the amount and variety of training data is increased without requiring the expense, effort and privacy concerns associated with acquiring additional images of medical procedure. Further, removing sub-regions that do not include the object of interest from the training data better focuses the training.

Returning to FIG. 1, at step 102, a true object/non-object mapping is determined for each target sub-region. The true object/non-object mapping provides an indication for each pixel in a target sub-region of whether the pixel represents an object or the pixel represents a non-object. In accordance with one embodiment, the true object/non-object mapping is provided through human annotation.

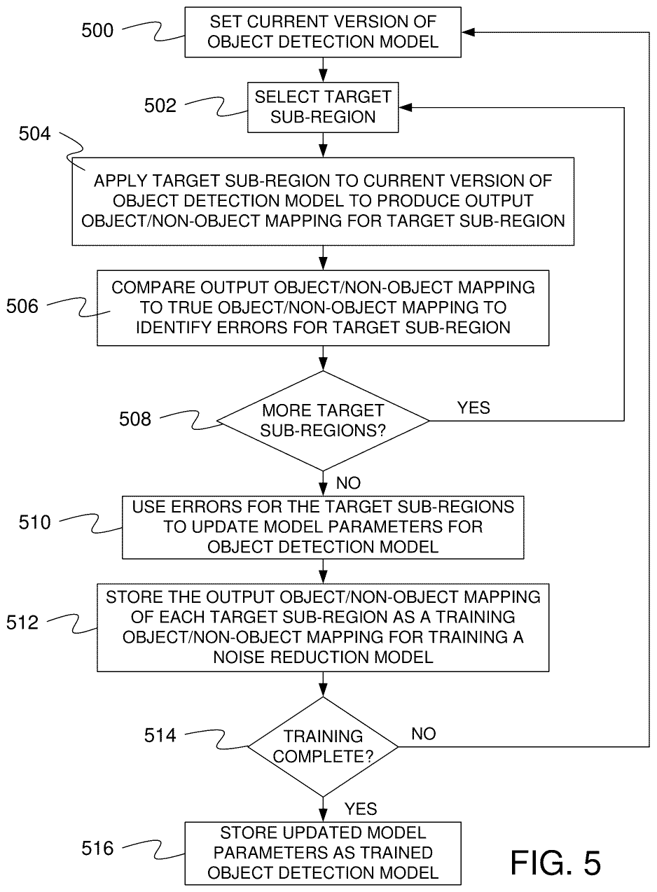

At step 104, object detection model 216 is trained using the target sub-regions. As part of training object detection model 216, training object/non-object mappings are created that can be used to train noise reduction model 218. Like the true object/non-object mappings, the training object/non-object mappings provide an indication of which pixels represent an object and which pixels do not represent an object in the sub-region. However, the training object/non-object mapping typically includes one or more errors when compared to the true object/non-object mapping. Details for creating the training object/non-object mappings is provided below in connection with the flow diagram of FIG. 5.

In step 500 of FIG. 5, the current version of the object detection model is set. When first beginning, the current version is set based on initial model parameters for the object detection model.

At step 502, one of the target sub-regions is selected and at step 504 the target sub-region is applied to the current version of the object detection model to produce an output object/non-object mapping for the target sub-region. The output object/non-object mapping includes an indication for each pixel in the sub-region as to whether it represents part of the object of interest or does not represent part of the object of interest.

At step 506, the output object/non-object mapping is compared to the true object/non-object mapping to identify a set of errors for the target sub-region. The errors are pixels that the true mapping indicates are part of the object but the output mapping indicates are not part of the object and pixels that the true mapping indicates are not part of the object but the output mapping indicates are part of the object.

At step 508, the method determines if there are more target sub-regions. If there are more target sub-regions, the next target sub-region is selected by returning to step 502 and steps 504 and 506 are repeated for the next target sub-region. The iterations of steps 502, 504 and 506 results in a set of errors for each target sub-region and an output object/non-object mapping for each sub-region for the current version of the object detection model.

When all of the target sub-regions have been processed at step 508, the errors for the target sub-regions are used to update model parameters for the object detection model so as to reduce the number of errors produced by the object detection model.

At step 512, the output object/non-object mappings of the target sub-regions are stored as training object/non-object mappings for training noise reduction model 218. Note that the errors in the output object/non-object mappings represent noise in the mappings. Thus, the output object/non-object mappings represent noisy object/non-object mappings that can be used during training of noise reduction model 218 without requiring additional field data from a medical procedure.

At step 514, processor 208 determines if the training of object detection model 216 is complete such as when the model parameters have converged to stable values. If the training is not complete, processor 208 returns to step 500 to select the updated model parameters for the object detection model as the current version of the object detection model. Steps 502-512 are then repeated for the new current version of the object detection model. This produces a new set of updated model parameters and a new set of training object/non-object mappings for the target sub-regions. Steps 502-512 are iterated until training is complete resulting in a large number of training object/non-object mappings and a fully-trained object completion model. When training is complete, the final model parameters are stored as trained object detection model 216 at step 516.

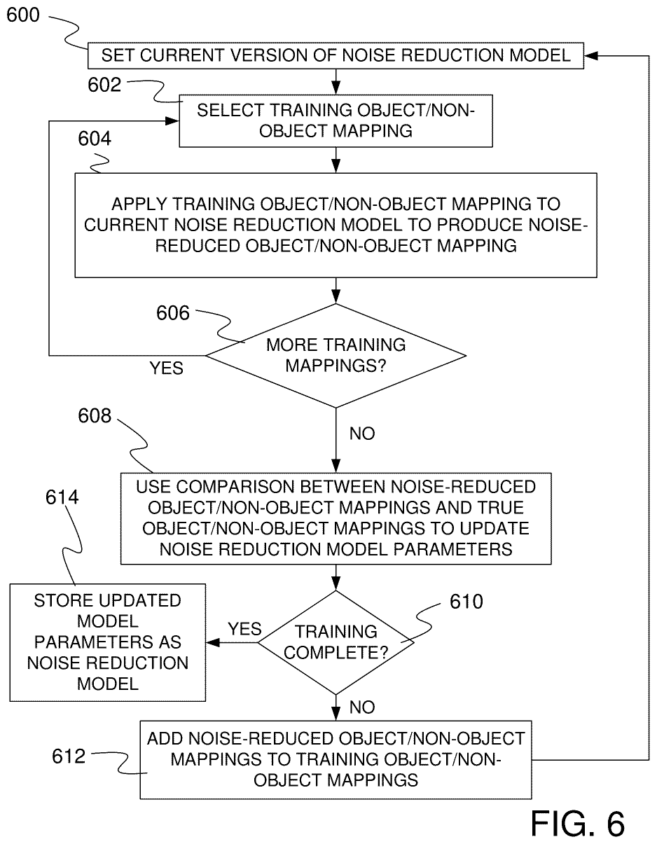

Returning to FIG. 1, after training the object detection model and forming the training object/non-object mappings at step 104, noise reduction model 218 is trained at step 106. FIG. 6 provides a method of training noise reduction model 218 in accordance with one embodiment. Under the method, additional training object/non-object mappings are generated to provide additional training data for training noise reduction model 218 without requiring additional field data.

In step 600 of FIG. 6, a current version of the noise reduction model is set. For the first pass through the method of FIG. 6, initial model parameters are set as the current version of noise reduction model 218. At step 602, a training object/non-object mapping is selected and at 604 is applied to the current version of noise reduction model 218 to produce a noise-reduced object/non-object mapping.

At step 606, processor 208 determines if there are more training object/non-object mappings. If there are more training mappings, the process returns to step 602 to select the next training object/non-object mapping. The next training object/non-object mapping is then applied to the current version of noise reduction model 218 to produce another noise-reduced object/non-object mapping at step 604. Steps 602 and 604 are iterated for each training object/non-object mapping resulting in a noise-reduced object/non-object mapping for each training object/non-object mapping.

When all of the training object/non-object mappings have been processed at step 606, each noise-reduced object/non-object mapping is compared to the corresponding true object/non-object mapping to identify errors in the noise-reduced object/non-object mapping. The errors are pixels that the true mapping indicates are part of the object but the noise-reduced mapping indicates are not part of the object and pixels that the true mapping indicates are not part of the object but the noise-reduced mapping indicates are part of the object.

The errors across all of the noise-reduced object/non-object mappings are then used to update the model parameters for the noise reduction model so as to reduce the number of errors.

At step 610 determines if the training of noise reduction model 610 is complete. For example, processor 208 can determine whether the model parameters have converged to stable values.

If training is not complete at step 610, the noise-reduced object/non-object mappings are added to the training object/non-object mappings at step 612 to increase the amount of training data available for the next iteration of training for noise reduction model 218. Thus, this embodiment further increases the training data without requiring additional field data thereby improving the performance of the final noise reduction model 218.

After step 612, the method of FIG. 6 returns to step 600 to select a new current version of noise reduction model 218. In particular, at step 600, the updated model parameters are used as the current version of noise reduction model 218.

Steps 600-612 are iterated until training is complete at step 610 with each iteration providing update parameters for noise reduction model 218 and additional training object/non-object mappings for the next iteration of training.

When the noise reduction model is fully trained, the last update to the model parameters is stored as noise reduction model 218 at step 614.

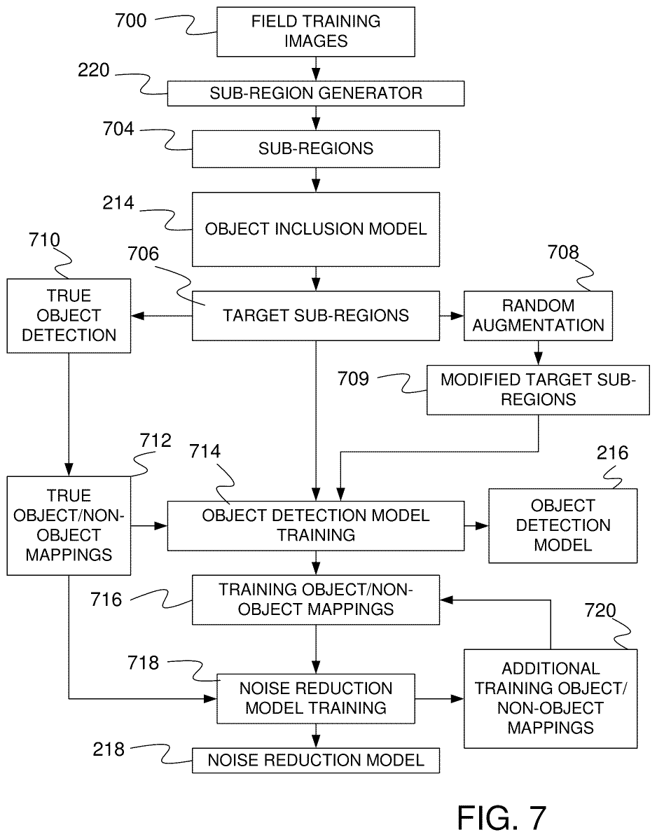

FIG. 7 provides a process diagram of the methods described above. In FIG. 7, a limited number of field training images 700 is received by sub-region generator 220, which produces sub-regions 704 as indicated by step 304 above. Sub-regions 704 are applied to object inclusion model 214 to identify target sub-regions as indicated by step 306 above. True object detection 710 is applied to the target sub-regions to identify true object/non-object mappings 712 as indicated by step 102 above. Modified target sub-regions 709 can be generated through random augmentation 708 of target sub-regions 706. In accordance with one embodiment, random augmentation 708 randomly changes a plurality of pixels in each target sub-region 706 to form the modified target sub-regions 709. Each modified target sub-region 709 covers the same portion of a field training image as one of the target sub-regions and is associated with the same true object/non-object mapping as the target sub-region it is formed from. Forming modified target sub-regions 709 is optional.

Target sub-regions 708, true object/non-object mappings 712 and modified target sub-regions 709 (if any) are provided to object detection model training 714, which performs the steps of FIG. 5 to produce object detection model 216 and training object/non-object mappings 716. Training object/non-object mappings 716 and true object/non-object mappings 712 are provided to noise reduction training 718, which performs the method of FIG. 6 to train noise reduction model 218. As indicated in FIG. 6, the training is iterative with each iteration forming additional training object/non-object mappings 720 that are used in the next training iteration by noise reduction model training 718.

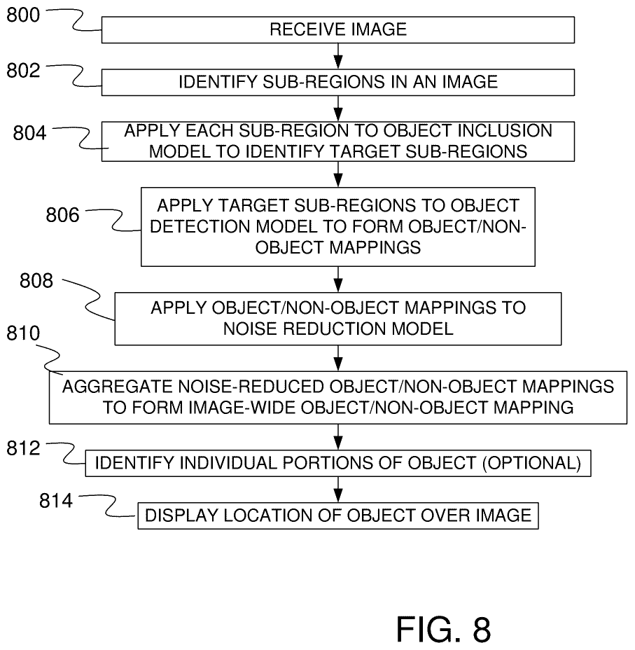

After object inclusion model 214, object detection model 216 and noise-reduction model 218 have been fully trained, these models can be used to identify an object in an image and to display the location on the image as found in the method of FIG. 8.

In step 800, an image 201 is received. The image may be received from a memory location or may be received from an imaging device in real time such as a radiological image received during a medical procedure.

At step 802, sub-region generator 220 defines sub-regions on the received image in the same manner that sub-regions were defined on the training images. At step 804, the image content of each sub-region is applied to object inclusion 214 to identify target sub-regions that include the entirety of the object of interest with some confidence level, such as 99%. In step 804, multiple sub-regions are identified as target sub-regions and sub-regions that are identified as not including the entirety of the object of interest are discarded and are not used in any of the steps discussed below.

At step 806, each target sub-region is applied to object detection model 216 to produce a separate output object/non-object mapping for each target sub-region. At step 808, each output object/non-object mapping is applied to noise reduction model 218 resulting in a separate noise-reduced object/non-object mapping for each target sub-region.

Because a separate noise-reduced object/non-object mapping is produced for each target sub-region, object detection model 216 and noise reduction model 218 are given multiple opportunities to identify the location of the object in the image. To further improve the identification of the location of the object in the image, the noise-reduced object/non-object mappings are aggregated at step 810 by an aggregator 222 to form an image-wide object/non-object mapping. In accordance with one embodiment, this aggregation involves examining the mappings for each pixel in the image and selecting the object/non-object mapping that is most common among the mappings for the pixel. For example, if three of the noise-reduced object/non-object mappings included a value for a pixel with two of the noise-reduced mappings indicating that the pixel is part of the object and the other noise-reduced mapping indicating that the pixel is not part of the object, the pixel would be designated as part of the object in the image-wide mapping. All pixels in the image that are not part of any of the target sub-regions are designated as not being part of the object. Note that different pixels will appear in different combinations of noise-reduced object/non-object mappings.

The image-wide object/non-object mapping provides the pixels that are part of the object. This information can then be used to identify individual portions of the part in an optional step 812 performed by an object part detector 224. In accordance with one embodiment, the individual portions of the part are identified by using the edges of the part to define a skeleton running down the middle of the part. The light intensity along this skeleton is then measured to mathematically compute and identify transitions in the intensity. Each transition is then marked as a border of a portion of a part. For example, if the part is a lead containing a set of spaced electrodes, the changes in light intensity along the skeleton indicate the edges of the electrodes along the lead.

At step 814, the location of the object is displayed over the image on display 206 by an image generator 226. In accordance with one embodiment, the image from imaging device 204 is displayed with the color of the pixels corresponding to the part being changed to indicate the part's location. In accordance with one embodiment, different portions of the part, such as different electrodes, are given different colors to assist in identifying the different portions of the part.

The method of FIG. 8 can be implemented during a medical procedure. For instance, the real time location of a lead having spaced electrodes can be displayed to a physician while the physician is inserting the lead into a patient. This aids the physician in the proper placement of the lead. In some such embodiments, part of the human anatomy is included as part of the object of interest such that the display highlights both the location of the anatomical part and the location of the lead so that the physician can place the lead relative to the anatomical part. In particular, the method of FIG. 8 can be used during implantation of leads used in Sacral Neuromodulation.

In other embodiments, the location and orientation of the object determined in FIG. 8 is used to identify a part of an image that is to be searched for anatomical structures. In such embodiments, the object can be a lead inserted in a patient or a probe that a physician places in or near the patient to indicate the area of interest.

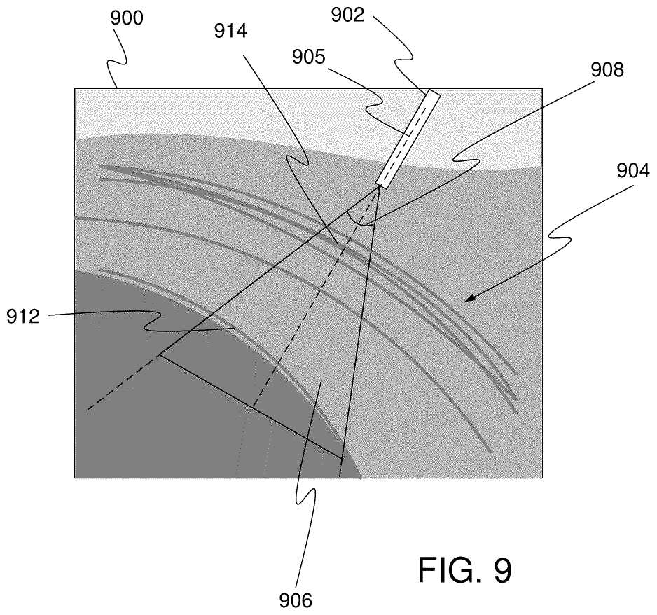

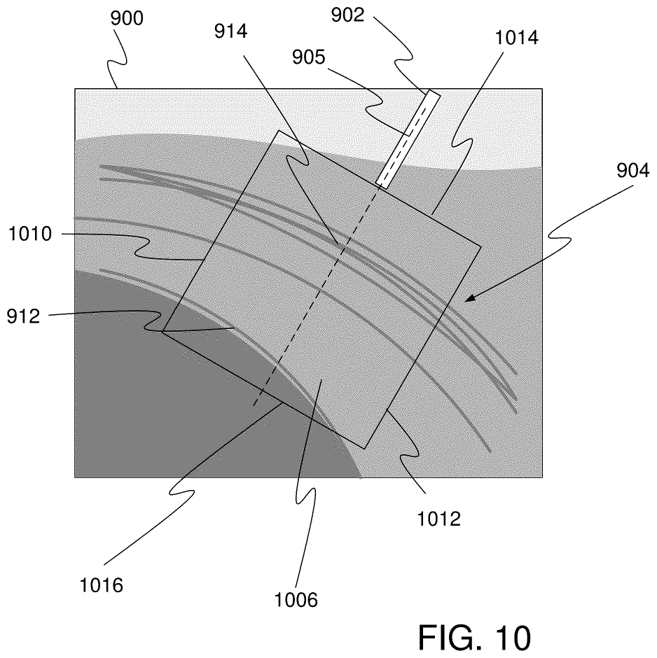

FIG. 9 shows and image 900 containing a probe 902 positioned outside a patient near the patient's sacrum 904. Image 900 is generally a grainy image in which several anatomical features are present. The method of FIG. 8 is used to determine the location of probe 902 in image 900. A primary axis 905 of probe 902 is determined from the locations of the edges of probe 902 in image 900. A bounded region is then defined relative to primary axis 905. In FIG. 9, a triangular bounded region 906 is defined that spans an angle 908 that has the primary axis 905 at its center and that extends outward from the end of probe 902. In FIG. 10, a rectangular bounded region 1006 is defined that has two spaced apart sides 1010 and 1012 that are parallel to primary axis 905 and two spaced apart sides 1014 and 1016 that are orthogonal to primary axis 904, with side 1014 next to probe 902.

A search for dorsal surface 914 and pelvic surface 912 of the sacrum is then performed. This search is limited to being performed within the bounded region 906/1006. This reduces the amount of processing required to identify the location of the sacral surfaces since the entirety of image 900 does not need to be searched.

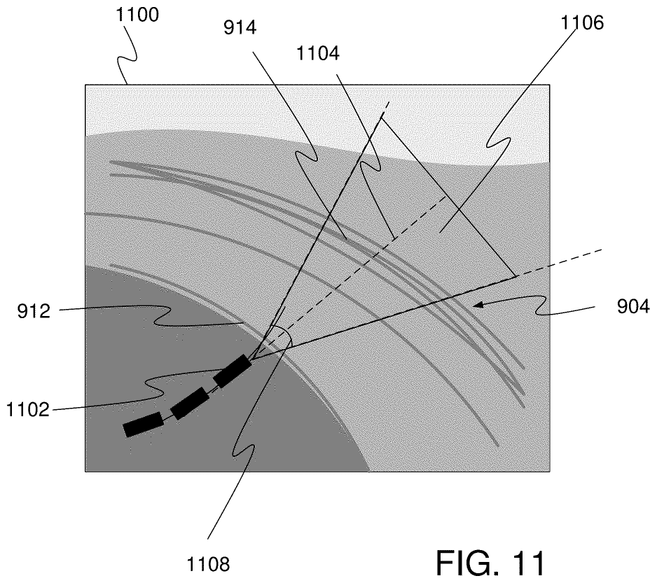

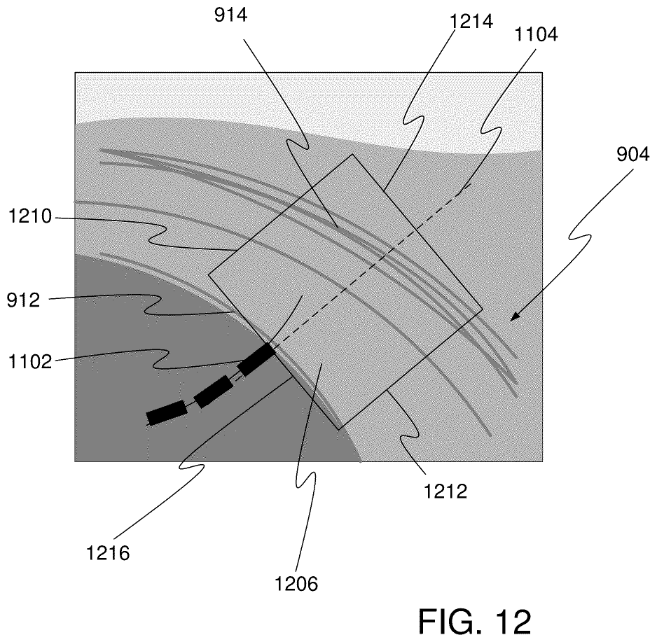

Alternatively, the location and orientation of an implanted lead is used to define the bounded region. FIG. 11 shows a lead 1102 in an image 1100. The method of FIG. 8 is used to determine the location of lead 1102 in image 1100. A primary axis 1104 of a portion of lead 1102 is determined from locations of the edges of lead 1102. In FIG. 11, a bounded region 1106 is defined that spans an angle 1108 that has primary axis 1104 at its center and that extends outward from a part of lead 1102. In FIG. 12, a rectangular bounded region 1206 is defined that has two spaced apart sides 1210 and 1212 that are parallel to primary axis 1104 and two spaced apart sides 1214 and 1216 that are orthogonal to primary axis 1104.

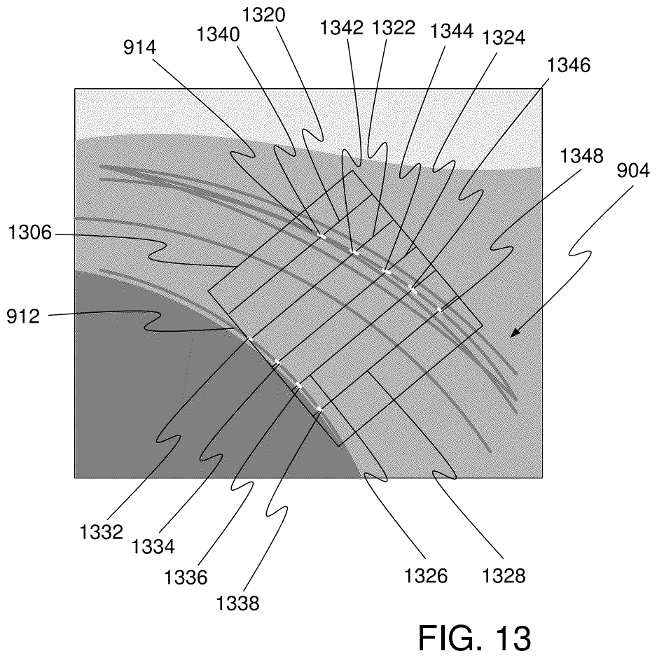

In accordance with one embodiment, the search for the sacral surfaces involves using a set of lines that are parallel to the primary axis within the bounded region, such as bounded regions 906, 1006, 1106 and 1206. FIG. 13 shows an example of a rectangular bounded region 1306 with a set of lines 1320, 1322, 1324, 1326 and 1328 that are each parallel to a primary axis of either a probe or a lead (not shown for simplicity). The system detects sequential patterns in pixel intensities along the lines to identify intensity transition points associated with sacral cortical boundaries. This allows determination of both the dorsal (top) and pelvic (bottom) sacral surfaces in lateral images. In FIG. 13, white lines 1332, 1334, 1336 and 1338 indicate the detected positions of the dorsal sacral surface and white lines 1340, 1342, 1344, 1346 and 1348 indicate the detected positions of the pelvic sacral surface.

Once these surfaces are identified, one of the surfaces is selected as a reference surface for determining the position of the lead. The distance and angle between the lead and the selected surface is then measured. In some embodiments, a point on the reference surface is designated as an origin of a space and positions along the lead are described by coordinates in that space.

Object inclusion model 214, object detection model 216 and noise-reduction model 218 can be any artificial intelligence model including, for example, one or more neural networks. Further, although a particular, method of training and using such models has been described above, in other embodiments a different training system and/or collection of artificial intelligence models is used to convey the location of medical devices during medical procedures.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method of training artificial intelligence systems comprising:
receiving a set of images each containing an object of interest;
defining a set of sub-regions on each image, at least one sub-region having a smaller area than an area of the sub-region's respective image;
identifying each sub-region of each image that contains an entirety of the object of interest as a target sub-region;
identifying the pixels in each target sub-region that correspond to the object of interest to form a true object/non-object mapping for each target sub-region; and
using the target sub-regions as inputs to an artificial intelligence system and the true object/non-object mappings for the target sub-regions as expected outputs of the artificial intelligence system during training of the artificial intelligence system.

2. The method of claim 1 wherein the images are radiological images of the human body and the object of interest comprises a medical device.

3. The method of claim 2 wherein the object of interest comprises a plurality of objects of interest.

4. The method of claim 3 wherein identifying each sub-region that contains the entirety of the object of interest comprises identifying each sub-region that contains the entirety of each of the plurality of objects of interest.

5. The method of claim 4 wherein at least one object of interest of the plurality of objects of interest comprises a human body part.

6. The method of claim 1 wherein the set of sub-regions comprise sub-regions having the same dimensions as each other wherein the dimensions define an area that is less than an area of the image.

7. A method of identifying the location of objects in an image comprising:
identifying multiple sub-regions in the image that are likely to contain the objects;
for each identified sub-region, designating pixels in each sub-region that are likely to represent part of the objects as an object pixel;
for each pixel in the image, assigning an object designation to the pixel based on a number of identified sub-regions in which the pixel was designated as an object pixel.

8. The method of claim 7 wherein at least two of the multiple sub-regions overlap.

9. The method of claim 8 wherein identifying multiple sub-regions in the image that are likely to contain the objects comprises identifying multiple sub-regions that are unlikely to contain the objects and ensuring that the sub-regions that are unlikely to contain the objects are not used in the step of designating pixels that are likely to represent part of the objects.

10. The method of claim 7 further comprising:
for each identified sub-region, designating each pixel that is not likely to represent part of the objects as a non-object pixel such that each pixel in the sub-region is either designated as a non-object pixel or an object pixel, wherein together the designations of object pixel and non-object pixel for an object/non-object mapping for the sub-region;
for each sub-region, applying each object/non-object mapping for the sub-region to a noise reduction model to produce a noise-reduced object/non-object mapping;
wherein the noise reduction model changes a designation for at least one pixel in at least one object/non-object mapping to form the noise-reduced object/non-object mapping of at least one sub-region.

11. The method of claim 10 wherein assigning the object designation to the pixel in the image comprises assigning the object designation to the pixel based on a number of noise-reduced object/non-object mappings in which the pixel was designated as an object pixel.

12. The method of claim 10 wherein the noise reduction model is trained using object/non-object mappings of multiple sub-regions in each of a plurality of training images.

13. The method of claim 12 wherein the noise reduction model is trained through an iterative process comprising:
setting initial model parameters for the noise reduction model;
applying the object/non-object mappings of the multiple sub-regions in each of the plurality of training images to the noise reduction model to produce a noise-reduced object/non-object mapping for each of the multiple sub-regions of the plurality of training images;
adjusting the model parameters for the noise reduction model based on the noise-reduced object/non-object mappings to form a revised noise reduction model;
applying the object/non-object mappings and the noise-reduced object/non-object mappings for each of the multiple sub-regions of the plurality of training images to the revised noise reduction model to produce second noise-reduced object/non-object mappings; and
adjusting the model parameters for the noise reduction model based on the second noise-reduced object/non-object mappings to form a second revised noise reduction model.

14. The method of claim 7 wherein the images comprise images of a living body and the objects comprise a medical device placed in the living body.

15. The method of claim 14 wherein the method is performed during the process of placing the medical device in the living body.

16. A method of training a noise-reduction model, the method comprising:
applying image data to a partially trained object detection model to form a first object/non-object mapping;
applying the image data to a fully trained object detection model to form a second object/non-object mapping;
using both the first object/non-object mapping and the second object/non-object mapping to train the noise reduction model.

17. The method of claim 16 wherein the image data comprises a plurality of sub-regions of an image, wherein the plurality of sub-regions comprises sub-regions that partially overlap and each include the entirety of an object of interest.

18. The method of claim 16 wherein using both the first object/non-object mapping and the second object/non-object mapping to train the noise reduction model comprises:
designating the first object/non-object mapping and the second object/non-object mapping as training object/non-object mappings;
applying the training object/non-object mappings to a first iteration of noise reduction model to form noise-reduced object/non-object mappings;
using the noise-reduced object/non-object mappings to form a second iteration of the noise reduction model;
designating the noise-reduced object/non-object mappings as part of the training object/non-object mappings;
applying the training object/non-object mappings to the second iteration of the noise reduction model to form noise-reduced object/non-object mappings.

19. The method of claim 18 wherein using both the first object/non-object mapping and the second object/non-object mapping to train the noise reduction model further comprises:
repeating steps of:
using noise-reduced object/non-object mappings produced by a current iteration of the noise-reduction model to form a further iteration of the noise reduction model,
designating the noise-reduced object/non-object mappings produced by the current iteration of the noise-reduction model as part of the training object/non-object mappings, and
applying the training object/non-object mappings to the further iteration of the noise reduction model to form noise-reduced object/non-object mappings;
until the noise reduction model is fully trained.

20. The method of claim 18 wherein the image data comprises a plurality of sub-regions of an image, wherein the plurality of sub-regions comprises sub-regions that partially overlap and each include the entirety of an object of interest.
